(19) United States
(12) Patent Application Publication
(10) Pub. No.: US 2009/0230940 A1
(43) Pub. Date: Sep. 17, 2009

(54) VOLTAGE REGULATION SYSTEM USING ABRUPT METAL-INSULATOR TRANSITION

(75) Inventors: JungWook Lim, Daejeon-city (KR); Sun-Jin Yun, Daejeon-city (KR); Hyun-Tak Kim, Daejeon-city (KR); Yong-Wook Lee, Daejeon-city (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon-city (KR)

(21) Appl. No.: 12/294,578

(22) PCT Filed: Mar. 14, 2007
(86) PCT No.: PCT/KR2007/001253

§ 371 Date: Sep. 25, 2008

(30) Foreign Application Priority Data
Mar. 28, 2006 (KR) 10 2006 0028096
Oct. 10, 2006 (KR) 10 2006 0098638

(51) Int. Cl. G05F 3/02

(52) U.S. Cl. 323/304

(57) ABSTRACT

Provided is a voltage regulation system using an abrupt metal-insulator transition (MIT), which can regulate various zener voltages and can be easily manufactured. The voltage regulation system includes: an input power source: a series resistor connected in series to the input power source; and an MIT insulator connected in series to the series resistor, and undergoing an abrupt MIT such that the range of an output voltage regulated to be kept constant varies according to the resistance of the series resistor.

### TECHNICAL FIELD

The present invention relates to a voltage regulation system, and more particularly, to a voltage regulation system using an abrupt metal-insulator transition (MIT).

### BACKGROUND ART

Recently, insulators whose resistance varies according to a voltage applied thereto have been intensively studied. Particularly, insulators, which abruptly transit from an insulator to a metal (referred to as metal-insulator transition (MIT) insulators), have been completely demonstrated. It is known that an abrupt MIT is accompanied by a structural change. However, New Journal of Physics Volume 6 page 52 by Hyun-Tak Kim, et al. teaches that a MIT is observed without a structural change when an electric field is applied to a VO₂ based device. MIT insulators whose resistance is changed by a MIT can be used as various devices. For example, MIT insulators can be used as voltage regulator circuits for protecting devices from a high electric field.

FIG. 1 is a graph illustrating a voltage-current curve of a conventional zener diode for voltage regulation. The conventional zener diode may be typically formed by doping impurities into a silicon semiconductor.

Referring to FIG. 1, when a voltage is increased because the conventional zener diode is reverse biased, the zener diode lets more current flow to keep the voltage across the conventional zener diode at a zener voltage V_{z}. The conventional zener diode uses a breakdown field that is caused by avalanche multiplication of charge carriers at the zener voltage V_{z}. The conventional zener diode protects a device by keeping the voltage constant. However, the conventional zener diode fails to have a zener voltage V_{z} tailored for each device.

U.S. Patent Publication No. 2004/0051096A1 issued to Richard. P. Kingsborough et al., discloses a new zener diode that enables precise tailoring of a zener voltage. The new zener diode in this patent is comprised of an organic semiconductor, instead of silicon. In detail, the new zener diode is fabricated by combining various organic materials and inorganic electrodes. The new zener diode can regulate a zener voltage V_{z} through the combination of the organic and inorganic materials. However, the new zener diode has problems in that the zener diode is limited to the organic semi-conductor, there may be a stress due to the combination of the organic and inorganic materials, and the materials are combined in a complex manner to regulate the zener voltage V_{z}.

### DISCLOSURE OF INVENTION

### Technical Problem

The present invention provides a voltage regulation system that can regulate a zener voltage using an abrupt metal-insulator transition (MIT) and can be easily manufactured.

### Technical Solution

According to an aspect of the present invention, there is provided a voltage regulation system using an MIT, the voltage regulation system comprising: an input power source: a series resistor connected in series to the input power source; an MIT insulator connected in series to the series resistor, and undergoing an abrupt MIT such that the range of a voltage output from the MIT insulator, which is regulated to be kept constant, varies according to the resistance of the series resistor; a first electrode disposed on a first side of the MIT insulator and connected to the input power source; and a second electrode disposed on a second side of the MIT insulator and connected to the series resistor.

### Advantageous Effects

When the MIT insulator transits to a metal, the series resistor may have a resistance greater than or equal to that of the metal. As the resistance of the series resistor increases, the voltage regulation range may increase.

### DESCRIPTION OF DRAWINGS

The above and other features and advantages of the present invention will become more apparent by describing in detail exemplary embodiments thereof with reference to the attached drawings in which:

FIG. 1 is a graph illustrating a voltage-current curve of a conventional zener diode for regulating a voltage;

FIG. 2 is a graph illustrating a voltage-current characteristic of a metal-insulator transition (MIT) insulator made of AlₓTi_{y}O according to an embodiment of the present invention;

FIG. 3 is a circuit diagram for explaining a voltage regulation system according to an embodiment of the present invention;

FIG. 4 is a graph illustrating a relationship between an input voltage Vᵢ and an output voltage Vₒ when the resistance of a series resistor R_{c} of the voltage regulation system of FIG. 3 is fixed; and

FIG. 5 is a graph illustrating a relationship between an input voltage Vᵢ and an output voltage Vₒ when the resistance of the series resistor R_{c} of the voltage regulation system of FIG. 3 is not fixed.

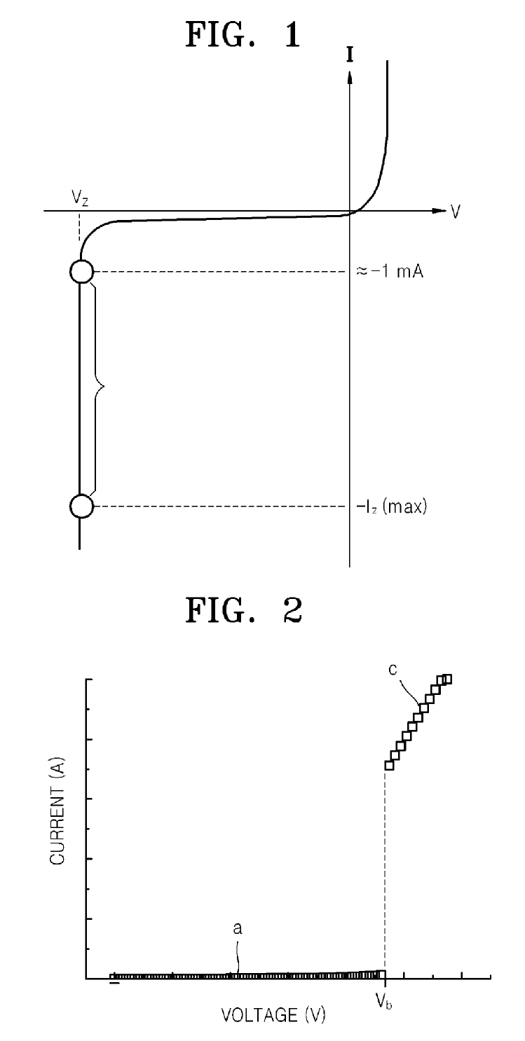

### BEST MODE

The present invention will now be described more fully with reference to the accompanying drawings, in which exemplary embodiments of the invention are shown. The invention may, however, be embodied in many different forms and should not be construed as being limited to the embodiments set forth herein; rather these embodiments are provided so that this disclosure will be thorough and complete, and will fully convey the concept of the invention to those skilled in the art. Like reference numerals denote like elements in the drawings.

The present invention proposes a voltage regulation system for regulating a voltage by maintaining a steady voltage across it. The voltage regulation system uses an abrupt metal-insulator transition (MIT) insulator that can regulate a voltage using its transition from an insulator (or semiconductor) to a metal. The resistance of the MIT insulator varies according to an electric field.

FIG. 2 is a graph illustrating a voltage-current characteristic of the MIT insulator made of AlₓTi_{y}O according to an embodiment of the present invention.

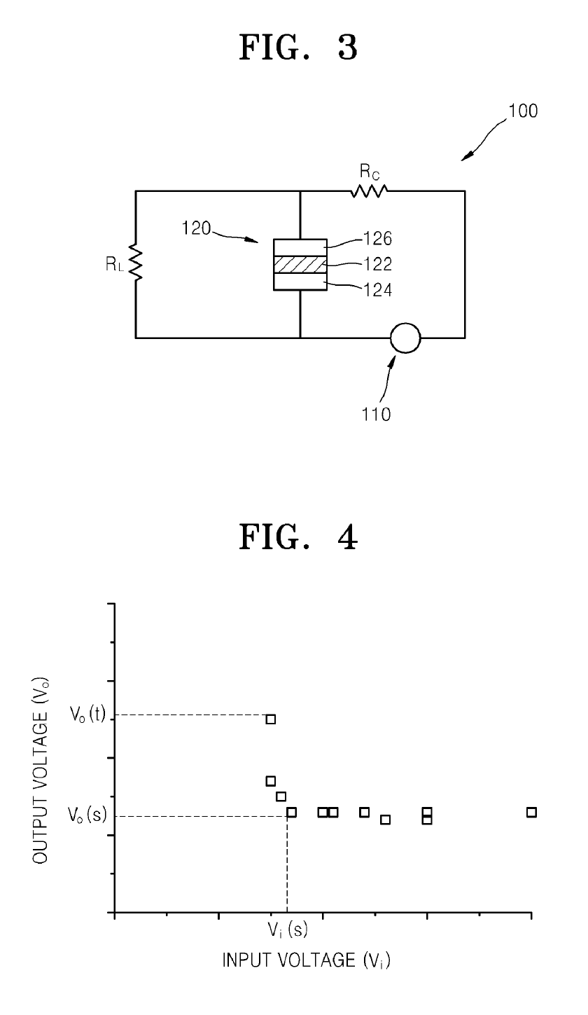

Referring to FIG. 2, the MIT insulator discontinuously transits from an insulator ‘a’ to a metal ‘c’. That is, the electrical properties of the MIT insulator are abruptly changed at a critical voltage V_{b} from the insulator ‘a’ to the metal ‘c’. In detail, when a voltage input to both ends of the MIT insulator ranges from 0 V to the critical voltage V_{b}, the MIT insulator becomes the insulator ‘a’ with negligible current flow, and when the voltage applied to both the ends of the MIT insulator is greater than the critical voltage V_{b}, the MIT insulator becomes the metal ‘c’. That is, a discontinuous current jumps occurs at the critical voltage V_{b}. The metal ‘c’ has a great number of electrons, and has a constant resistance such that current is linearly increased in accordance with an increase in the voltage. The MIT insulator can regulate a voltage by being connected in series to a resistor R_{c} (see FIG. 3) as will be explained later.

The MIT insulator according to the present embodiment can induce a MIT again even when the applied electric field is removed and a voltage is applied from 0V. However, a conventional zener diode is not guaranteed to do so since it uses a breakdown voltage. Meantime, the critical voltage V_{b} may vary according to the structure of an MIT device including the MIT insulator and the electrical properties of materials used to form the MIT device.

The MIT insulator may be formed of at least one material selected from the group consisting of an inorganic semiconductor to which low-concentration holes are added, an inorganic insulator to which low-concentration holes are added, an organic semi-conductor to which low-concentration holes are added, an organic insulator to which low-concentration holes are added, a semiconductor to which low-concentration holes are added, an oxide semiconductor to which low-concentration holes are added, and an oxide insulator to which low-concentration holes are added, wherein the above-described materials each include at least one of oxygen, carbon, a semiconductor element (i.e., groups III-V and groups I-IV), a transition metal element, a rare-earth element, and a lanthanum-based element. The MIT insulator, which has various resistances when it is the metal ‘c’, may be at least one selected from the group consisting of a Ti-containing oxide layer, such as AlₓTi_{y}O, ZnₓTi_{y}O, ZrₓTi_{y}O, TaₓTi_{y}O, VₓTi_{y}O, LaₓTi_{y}O, BaₓTi_{y}O, or SrₓTi_{y}O, an oxide layer, such as Al₂O₃, VO₂, ZrO₂, ZnO, HfO₂, Ta₂O₅, La₂O₃, NiO, or MgO, a compound, such as GAS, GaSb, InP, InAs, or GST(GeSbTe), and a semiconductor such as Si, or Ge.

FIG. 3 is a circuit diagram for explaining a voltage regulation system 100 according to an embodiment of the present invention.

Referring to FIG. 3, the voltage regulation system 100 includes an input power source 110, a series resistor R_{c} connected in series to the input power source 110, and an MIT device 120 connected in series to the series resistor R_{c}. The voltage regulation system 100 may be connected in parallel to an electrical system R_{L}. A voltage regulated by the voltage regulation system 100 is applied to the electrical system R_{L}.

The range of a voltage output from the MIT device 120, which is regulated to be kept constant (referred to as voltage regulation range), varies according to the resistance of the series resistor R_{c} as will be explained later. The MIT device 120 includes an MIT insulator 122 undergoing an abrupt MIT, a first electrode 124 disposed on a first side of the MIT insulator 122 and connected in series to the input power source 110, and a second electrode 126 disposed on a second side of the MIT insulator 122 and connected in series to the series resistor R_{c}.

Each of the first electrode 124 and the second electrode 126 may be made of at least one material selected from the group consisting of Li, Be, C, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Sb, Cs, Ba, La, Hf, Ta, W, Re, Os, Ir, Pt, Au, Hg, Pb, Bi, Po, Ce, Pr, Nd, Sm, Eu, Gd, Th, Dy, Ho, Er, Tm, Yb, Lu, Th, U, Np, Pu, a compound thereof, an oxide thereof, and an oxide of the compound. Upon a transition to a metal, current flows in a direction perpendicular to the MIT insulator 122, but the present embodiment is not limited thereto. Although not described, the MIT device 120 may be configured such that current flows in a direction parallel to the MIT insulator 122 as well.

Although there is no limitation in forming the layers of the MIT device 120, the respective layers of the MIT device 120 may be formed by s puttering, molecular beam epitaxy (MBE), E-beam evaporation, thermal evaporation, atomic layer epitaxy (ALE), pulsed laser deposition (PLD), chemical vapor deposition (CVD), sol-gel deposition, or atomic layer deposition (ALD). Meantime, the resistance of the MIT insulator 122 varies according to the electrical characteristic of the MIT insulator 122 and the structure of the MIT device 120. In detail, the MIT device 120 can regulate a voltage by being connected to the series resistor R_{c}. The resistance of the series resistor R_{c} can range from several Ω to several KΩ, and the voltage regulation performance of the MIT device 120 varies according to the resistance of the series resistor R_{c} as will be explained later.

An MIT used in the voltage regulation system according to the present embodiment is observed in most insulators and semiconductors. Accordingly, if there is no stress, voltage regulation can be achieved by depositing the MIT insulator 122 on any substrate. Also, process temperature can be set over a wide range from room temperature to 900° C. Since the MIT insulator 122 can have a single layered structure, the voltage regulation system can be easily manufactured.

FIG. 4 is a graph illustrating a relationship between an input voltage Vᵢ and an output voltage Vₒ when the resistance of the series resistor R_{c} of the voltage regulation system of FIG. 3 is fixed. Here, the MIT insulator 122 is a AlₓTi_{y}O thin film made by plasma enhanced ALD. The resistance of the series resistor R_{c} is greater than the resistance of the AlₓTi_{y}O thin film in a metal state.

Referring to FIG. 4, as the input voltage Vᵢ varies, the output voltage Vₒ varies from a transient output voltage Vₒ(t) to a constant saturation output voltage Vₒ(s). Before the input voltage Vᵢ reaches the voltage regulation range, the output voltage Vₒ increases in proportion to the input voltage Vᵢ. The output voltage Vₒ emitted from the MIT device 120 of FIG. 3 is maintained constant at the saturation output voltage Vₒ(s) although the input voltage Vᵢ exceeds the saturation input voltage Vᵢ(s). That is, when the input voltage Vᵢ increases above the saturation input voltage Vᵢ(s), a constant amount of voltage is applied to the MIT device 120, and the rest voltage is applied to the series resistor R_{c}. Accordingly, the voltage regulation system according to the present embodiment can maintain a steady voltage across it using the MIT device 120 although the input voltage Vᵢ increases.

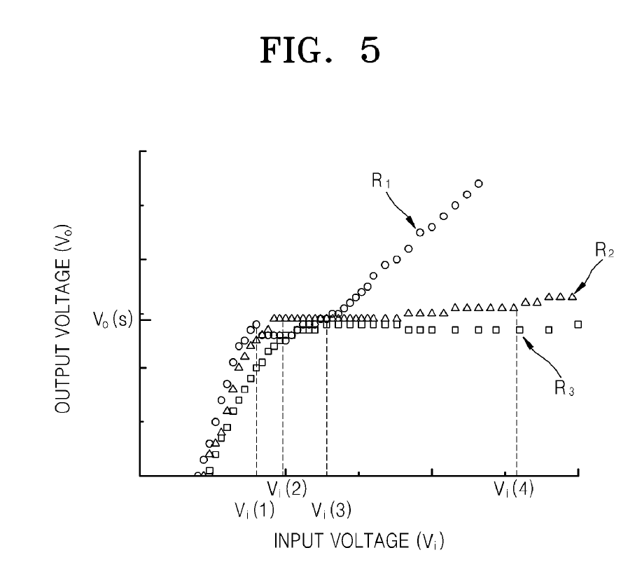

FIG. 5 is a graph illustrating a relationship between an input voltage Vᵢ and an output voltage Vₒ when the resistance of the series resistor R_{c} of the voltage regulation system of FIG. 3 is not fixed. Here, the MIT insulator 122 is a AlₓTi_{y}O thin film made by plasma enhanced ALD. The resistance of the series resistor R_{c} ranges from several Ω to several KΩ. In the graph of FIG. 5, ◯, Δ, and □ represent the resistances R₁, R₂, and R₃ of the series resistor R_{c}, respectively. Here, the resistances R₁, R₂, and R₃ are in a relationship R₁<R₂<R₃. The resistance R₁ may be similar to the resistance of the MIT insulator 122 in a metal state.

Referring to FIG. 5, the voltage regulation range is wider with the higher resistance R₃ than with the lower resistance R₁. In detail, the resistance R1 results in a voltage regulation range of approximately Vᵢ(1) to Vᵢ(3), the resistance R₂ results in a voltage regulation range of approximately Vᵢ(1) to Vᵢ(4), and the resistance R₃ results in a voltage regulation range of approximately Vᵢ(2) to above Vᵢ(4). Although the resistance of the series resistor R_{c} is changed, the output voltage Vₒ is maintained at almost Vₒ(s). When compared with the conventional zener diode made of silicon or an organic semiconductor, the voltage regulation system according to the present embodiment can easily adjust the voltage regulation range and a threshold voltage corresponding to a zener voltage by changing the material of the MIT insulator (or semi-conductor) 122. Also, while the conventional zener diode uses a breakdown field and thus has a limitation in the level of a regulated voltage, the voltage regulation system according to the present embodiment uses a transition from an insulator to a metal and thus can perform voltage regulation even at a high voltage.

Since a transition from an insulator (or semiconductor) to a metal is used, the voltage regulation system according to the present invention can use various MIT insulators. Also, the voltage regulation system can easily regulate a voltage and adjust a voltage regulation range by changing the composition or the resistance of the MIT insulator. Furthermore, the voltage regulation system can perform voltage regulation even at a high voltage using the MIT effect instead of a breakdown field. The voltage regulation system can stably operate for a long period of time because it can induce a MIT again even when an electric field is removed and a new voltage is applied from 0V. Since the voltage regulation system is hardly limited in the kind of a substrate, various substrates can be used.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A voltage regulation system using an abrupt metal-insulator transition (MIT), the voltage regulation system comprising:
an input power source:
a series resistor connected in series to the input power source;
an MIT insulator connected in series to the series resistor, and undergoing an abrupt MIT such that the range of a voltage output from the MIT insulator, which is regulated to be kept constant, varies according to the resistance of the series resistor;
a first electrode disposed on a first side of the MIT insulator and connected to the input power source; and
a second electrode disposed on a second side of the MIT insulator and connected to the series resistor.

2. The voltage regulation system of claim 1, wherein, when the MIT insulator transits to a metal, the series resistor has a resistance greater than or equal to that of the metal.

3. The voltage regulation system of claim 1, wherein, as the resistance of the series resistor increases, the voltage regulation range increases.

4. The voltage regulation system of claim 1, wherein, before an input voltage of the input power source reaches the voltage regulation range, the output voltage increases in proportion to the input voltage.

5. The voltage regulation system of claim 1, wherein, when an input voltage of the input power source is beyond the voltage regulation range, the output voltage increases in proportion to the input voltage.

6. The voltage regulation system of claim 1, wherein the MIT insulator discontinuously transits from an insulator to a metal.

7. The voltage regulation system of claim 1, wherein the MIT insulator is formed of at least one material selected from the group consisting of an inorganic semi-conductor to which low-concentration holes are added, an inorganic insulator to which low-concentration holes are added, an organic semiconductor to which low-concentration holes are added, an organic insulator to which low-concentration holes are added, a semiconductor to which low-concentration holes are added, an oxide semiconductor to which low-concentration holes are added, and an oxide insulator to which low-concentration holes are added, wherein the above-described materials each include at least one of oxygen, carbon, a semi-conductor element (i.e., groups III-V and groups II-IV), a transition metal element, a rare-earth element, and a lanthanum-based element.

8. The voltage regulation system of claim 1, wherein the MIT insulator is formed of at least one material selected from the group consisting of AlₓTi_{y}O, ZnₓTi_{y}O, ZrₓTi_{y}O, TaₓTi_{y}O, VₓTi_{y}O, LaₓTi_{y}O, BaₓTi_{y}O, SrₓTi_{y}O, Al₂O₃, VO₂, ZrO₂, ZnO, HfO₂, Ta₂O₅, La₂O₃, NiO, MgO, GaAS, GaSb, InP, InAs, GST(GeSbTe), Si, and Ge.

9. The voltage regulation system of claim 1, wherein each of the first electrode and the second electrode is made of at least one material selected from the group consisting of Li, Be, C, Na, Mg, Al, K, Ca, Sc, Ti, V, Cr, Mn, Fe, Co, Ni, Cu, Zn, Ga, Rb, Sr, Y, Zr, Nb, Mo, Tc, Ru, Rh, Pd, Ag, Cd, In, Sn, Sb, Cs, Ba, La, Hf, Ta, W, Re, Os, Ir, Pt, Au, Hg, Pb, Bi, Po, Ce, Pr, Nd, Sm, Eu, Gd, Tb, Dy, Ho, Er, Tm, Yb, Lu, Th, U, Np, Pu, a compound thereof, an oxide thereof, and an oxide of the compound.

10. The voltage regulation system of claim 1, wherein the first electrode and the second electrode are spaced a predetermined distance from each other and partially cover both the first and second sides of the MIT insulator.

11. The voltage regulation system of claim 1, wherein the first electrode and the second electrode are spaced a predetermined distance from each other and partially cover both the first and second sides of the MIT insulator.

12. The voltage regulation system of claim 1, connected in parallel to an electrical system.

13. The voltage regulation system of claim 1, wherein a voltage regulated by the MIT insulator is applied to the electrical system.
